(19) United States
(12) Patent Application Publication
(10) Pub. No.: US 2019/0238076 A1
(43) Pub. Date: Aug. 1, 2019

(54) MOTOR CONTROL DEVICE

(71) Applicant: CANON KABUSHIKI KAISHA, Tokyo (JP)

(72) Inventor: Katsuyuki Yamazaki, Toride-shi (JP)

(21) Appl. No.: 16/355,991

(22) Filed: Mar. 18, 2019

Related U.S. Application Data
(63) Continuation of application No. PCT/JP2017/033903, filed on Sep. 20, 2017.

(30) Foreign Application Priority Data
Sep. 20, 2016 (JP) 2016-182634

(51) Int. Cl. H02P 8/12; H02P 5/46; H02P 21/18; H02P 21/22; H02P 8/34; G03G 15/00

(52) U.S. Cl. CPC H02P 8/12; H02P 5/46; G03G 15/602; H02P 21/22; H02P 8/34; H02P 21/18

(57) ABSTRACT

Provided is a motor control device capable of suppressing degradation in AD convert accuracy even when an A/D converter is shared by a plurality of motors. The motor control device provided to an image forming apparatus includes: a plurality of motors each including two or more phase coils; PWM function portions configured to control drive of the plurality of motors; motor drive controllers; and shared A/D converters configured to detect currents flowing through at least coils of two phases among phase coils of each of the plurality of motors and perform current detection for a plurality of phases of the each of the plurality of motors in a time-sharing manner.

### CROSS-REFERENCE TO RELATED APPLICATIONS

This application is a Continuation of International Patent Application No. PCT/JP2017/033903, filed Sep. 20, 2017, which claims the benefit of Japanese Patent Application No. 2016-182634, filed Sep. 20, 2016, both of which are hereby incorporated by reference herein in their entirety.

### BACKGROUND OF THE INVENTION

### Field of the Invention

The present disclosure relates to a motor control device, which is configured to generate PWM signals for a plurality of motors and convert drive currents for the plurality of motors into digital values.

### Background Art

In an electrophotographic image forming apparatus such as a copying machine or a printer, a stepping motor is used as a drive source for conveyance of a recording material (for example, a sheet) on which a copy image is to be recorded.

Speed control of the stepping motor can easily be performed through control of cycles of pulses to be applied to the motor without use of means for detecting speed or a position. Moreover, the stepping motor has an advantage in that position control for the stepping motor can also easily be performed through control of the number of pulses.

Meanwhile, there is a case in which, when the motor exceeds a range of torque that can be output by the motor, the stepping motor is brought into a step-out state in which the stepping motor is not in synchronization with input pulses and cannot be controlled. Therefore, careful handling of the stepping motor is required.

For example, in order to avoid the step-out state, it is required that a predetermined margin should be given to a load torque required for the device so that a motor output torque adaptable to a change in torque on a load side caused by variation of various kinds can be secured. As a result, there is a problem in that more power than required is consumed and that the surplus torque causes vibration and noise.

As one method for solving this problem, there has been proposed vector control (or a field oriented control (FOC)) (for example, Patent Literatures 1 and 2).

### CITATION LIST

### Patent Literature

PTL 1 U.S. Pat. No. 6,850,027 B2
PTL 2 Japanese Patent Laid-Open No. 6-225595

The above-mentioned vector control is a method of controlling a phase and an amplitude of a current so as to generate a maximum torque in a rotary coordinate system with a d-axis representing a magnetic-flux direction component of a rotor and a q-axis representing a direction orthogonal to the d-axis. In the rotary coordinate system, a q-axis current corresponds to a current component which generates the torque, and a d-axis current corresponds to a current component which generates the magnetic flux.

Moreover, when a permanent magnet is used for the rotor as in the case of the stepping motor, a magnetic field is generated by the permanent magnet. Thus, the d-axis current is not required, and hence torque control for the motor can be performed only through control of the q-axis current. As a result, a drive current for the motor in the stationary coordinate system exhibits an ideal sine current waveform, thereby not only enabling control with a highest power efficiency but also suppressing vibration and noise caused by the surplus torque.

Moreover, as a method of detecting a rotation speed and a position of the rotor which are required for the vector control, in general, there has been known a method using a rotary encoder. However, when the rotary encoder which is not required for the control of the stepping motor in the related art is newly added, increase in cost and increase in arrangement space are required.

As a measure for solving those problems, there has been known, for example, a method of detecting a drive current for the motor and estimating a rotor position through use of an inverse tangent of induced voltage ratios in an A-phase and a B-phase estimated based on a voltage equation. A rotor rotation speed can be determined by time-differentiating estimated position results.

On this occasion, a full bridge circuit of a field effect resistor (FET) is used as a drive driver for the stepping motor, and magnetization control of the FET is performed through use of pulse width modulation (PWM) signals to allow a drive current to flow through the motor. In such case, as a method of detecting the drive current, in general, there has been generally known a configuration of arranging a shunt resistor on a ground side of the bridge circuit, amplifying voltage applied to the resistor through use of an operational amplifier, and detecting the voltage through use of an A/D converter.

However, in the related-art method, it is required that the A/D converter include two high-precision analog circuits each having a high resolution less than or equal to 1% of a current and a voltage. For those analog circuits, it is required that the configuration of the FET with 24 V power supply be set to the configuration of achieving analog separation with respect to the motor driver of the full bridge configured to perform PWM drive.

For example, there is a case in which drive states of two adjacent motors and cyclic impulse noises such as DC power supply ripples or electromagnetic waves may degrade AD conversion accuracies (AD convert accuracies) of each other. Moreover, the A/D converter is required for each motor and all of two phases of each motor. Therefore, there still remains a problem in that the addition of the A/D converters causes a significant increase in cost in the entire device.

The present disclosure has an object to suppress degradation in mutual AD convert accuracy even when an A/D converter is shared by a plurality of motors.

### SUMMARY OF THE INVENTION

According to one embodiment of the present disclosure, there is provided a motor control device configured to control a plurality of motors, including: a generator configured to generate a plurality of PWM signals in association with the plurality of motors; a motor drive controller configured to output a plurality of drive currents corresponding to the plurality of motors based on the plurality of PWM signals having been generated; and an A/D converter configured to convert the plurality of drive currents into digital values; wherein a plurality of PWM cycles of the plurality of PWM signals are the same, wherein, in the plurality of PWM signals, a shorter width of a width of a high region of a PWM signal and a width of a low region of the PWM signal in each of the plurality of PWM cycles is present within a predetermined phase range in the each of the plurality of PWM cycles, and wherein the A/D converter converts the plurality of drive currents corresponding to the plurality of motors into digital values at different timings outside the predetermined phase range in the each of the plurality of PWM cycles.

Further features of the present invention will become apparent from the following description of exemplary embodiments with reference to the attached drawings.

### BRIEF DESCRIPTION OF THE DRAWINGS

FIG. 1 is a view for illustrating an example of a configuration of an image forming system in an embodiment of the present disclosure.

FIG. 2 is an explanatory block diagram for illustrating an example of a function configuration of a system controller included in an image forming apparatus.

FIG. 3 is an explanatory diagram for illustrating a function configuration of an interrupt controller IRQC included in the system controller.

FIG. 4 is a schematic view for illustrating an example of a configuration of a stepping motor.

FIG. 5A is an explanatory diagram for illustrating an example of position command pulses of a motor and interrupt timings of a timer.

FIG. 5B is an explanatory graph for showing an example of rotation speed control for the stepping motor.

FIG. 6 is a timing chart for illustrating an example of output of PWM signals in an A-phase of the stepping motor.

FIG. 7 is a timing chart for illustrating an example of detection timings of A/D converters through interruption by respective timers.

FIG. 8 is a flow chart for illustrating an example of timer interrupt control of the interrupt controller IRQC.

FIG. 9 is a flow chart for illustrating an example of processing procedures of Step S830 illustrated in FIG. 8.

FIG. 10 is a flow chart for illustrating an example of PWM data calculation processing in Step S560 (vector calculation mode) illustrated in FIG. 9.

FIG. 11 is a flow chart for illustrating an example of PWM data calculation processing in Step S570 (open calculation mode) illustrated in FIG. 9.

FIG. 12A is an explanatory diagram for illustrating an example of a full bridge circuit of a PWM function portion.

FIG. 12B is an explanatory diagram for illustrating an example of the full bridge circuit of the PWM function portion.

FIG. 12C is an explanatory diagram for illustrating an example of the full bridge circuit of the PWM function portion.

FIG. 13 is a graph for showing, with regard to four PWM signals and three AD converts based on a phase, an example of a relationship between PWM generation sections and AD convert timings, in a case in which PWM widths are described in parallel in a stepwise manner.

FIG. 14 is a graph for showing an example of a relationship between PWM generation sections and AD convert timings, in a case in which PWM widths of PWM signals given with respect to two motors in a related-art example are described in parallel.

FIG. 15 is a graph for showing an example of a relationship between PWM generation sections and AD convert timings, in a case in which five motors are controlled through timing control by the system controller.

### DESCRIPTION OF THE EMBODIMENTS

Now, as an example, description is made of an image forming apparatus including a motor control device having the present disclosure applied thereto.

### Embodiment

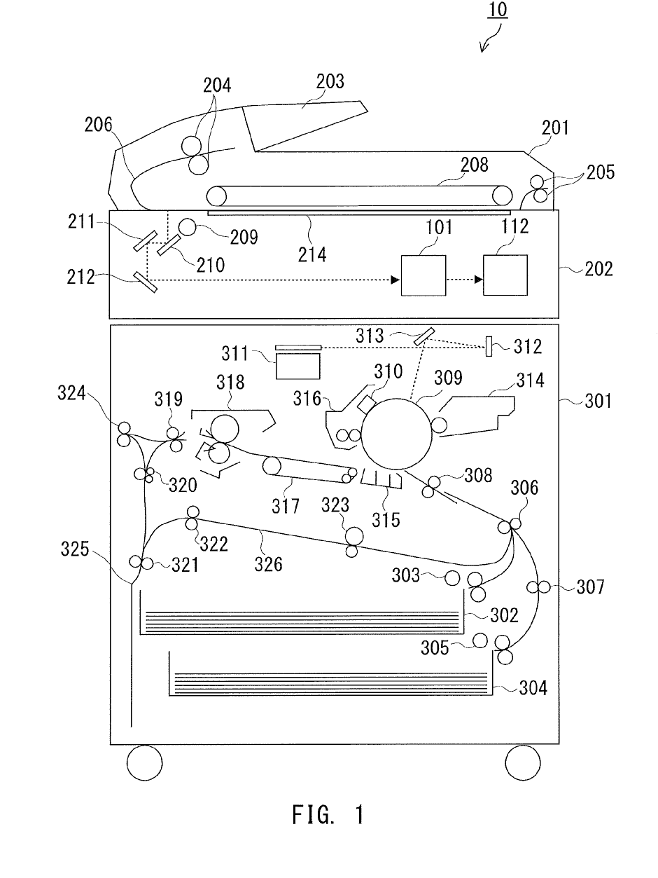

FIG. 1 is a view for illustrating an example of a configuration of an image forming system in an embodiment of the present disclosure.

An image forming system 10 illustrated in FIG. 1 includes an automatic document feeder (ADF) 201, a reader 202, and an image forming apparatus 301.

Originals placed on an original placement portion 203 of the automatic document feeder 201 are fed one by one by feed rollers 204, and are conveyed to an original glass table 214 of the reader 202 through a conveyance guide 206. Further, the originals are conveyed by a conveyance belt 208 at a constant speed, and are delivered to an outside of the apparatus by discharge rollers 205.

During the operation described above, at a reading position of the reader 202, light having been reflected on an original image illuminated by an illumination system 209 is converted into image signals in an image reader 101 through an optical system including reflection mirrors 210, 211, and 212. The image reader 101 includes, for example, lenses, charge coupled devices (CCDs) being photoelectric conversion elements, and a drive circuit for the CCDs.

The image forming apparatus 301 has, for example, a flow-reading mode and a fixed mode as reading modes for an original. In the flow-reading mode, the original image is read while an original is conveyed at constant speed under a state in which the illumination system 209 and the optical system remains stationary.

Moreover, in the fixed mode, an original is placed on the original glass table 214 of the reader 202. The original placed on the original glass table 214 is read while the illumination system 209 and the optical system are being moved at constant speed. Typically, sheet-shaped originals are read in the flow-reading mode, and bound originals are read in the fixed mode.

Image signals (read data) converted in the image reader 101 are formed in page unit on a recording material (for example, a sheet) by the image forming apparatus 301.

The image signals are modulated into signals of laser light, for example, by a semiconductor laser (not shown). The modulated signals of laser light proceed via a light scanning apparatus 311 and mirrors 312 and 313 by a polygon mirror and expose a surface of a photosensitive drum 309 having been uniformly charged by a charging device 310, thereby forming an electrostatic latent image.

The electrostatic latent image is developed with toner of a developing device 314, and a toner image is transferred onto a recording material by a transfer/separation device 315.

The recording materials are stored in sheet cassettes 302 and 304. In this embodiment, standard recording materials are stored in the sheet cassette 302, and tab sheets are stored in the sheet cassette 304.

The recording materials stored in the sheet cassette 302 are conveyed by a feed roller 303 and conveyance rollers 306, and are conveyed to a transfer position of the photosensitive drum 309 while a timing with a formed image is adjusted by registration rollers 308.

Meanwhile, the recording materials stored in the sheet cassette 304 are conveyed by a feed roller 305 and conveyance rollers 306 and 307, and are conveyed to the transfer position of the photosensitive drum 309 while a timing with a formed image is adjusted by the registration rollers 308. The recording material having the toner image transferred thereonto is conveyed to a fixing device 318 by a conveyance belt 317, and the toner on the recording material is fixed.

For example, when the image forming apparatus 301 is in a simplex printing mode, the recording material conveyed from the fixing device 318 is delivered to the outside of the apparatus by fixation discharge rollers 319 and discharge rollers 324. When the image forming apparatus 301 is in a duplex printing mode, the recording material is conveyed by reverse rollers 321 from the fixation discharge rollers 319 to a reverse path 325 via conveyance rollers 320.

Further, when rotation of the reverse rollers 321 is reversed immediately after a trailing end of the recording material has passed through a merging point with a duplex path 326, the recording material is revered and conveyed to the duplex path 326.

The recording material having been conveyed to the duplex path is conveyed by conveyance rollers 322 and 323. After the recording material passes via the conveyance rollers 306 again, and a timing with a back-side image is adjusted by the registration rollers 308, the recording material is subjected to transfer and fixation and is delivered to the outside of the apparatus.

Moreover, when the recording material conveyed from the fixing device 318 is to be turned over and delivered to the outside of the apparatus, the recording material is temporarily conveyed to the conveyance rollers 320. Then, rotation of the conveyance rollers 320 is reversed immediately before a trailing end of the recording material passes through the conveyance rollers 320, and the recording material is delivered to the outside of the apparatus.

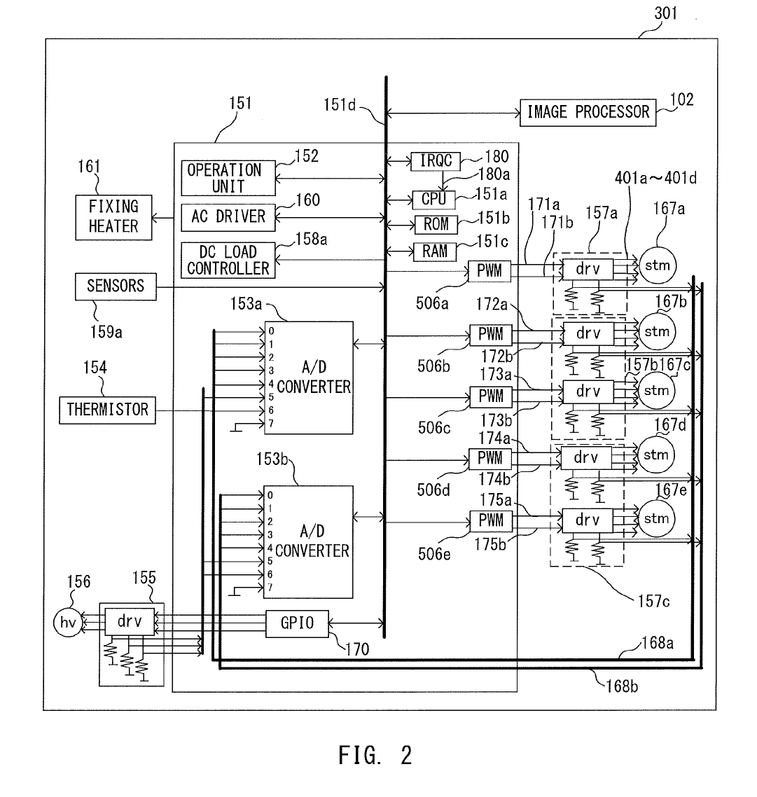

Drive of the conveyance rollers 306 and 307, the fixation discharge rollers 319, the reverse rollers 321, the conveyance rollers 322 and 323, the discharge rollers 324, and the like, which are provided in the image forming apparatus 301, is controlled by a system controller 151 illustrated in FIG. 2 described later.

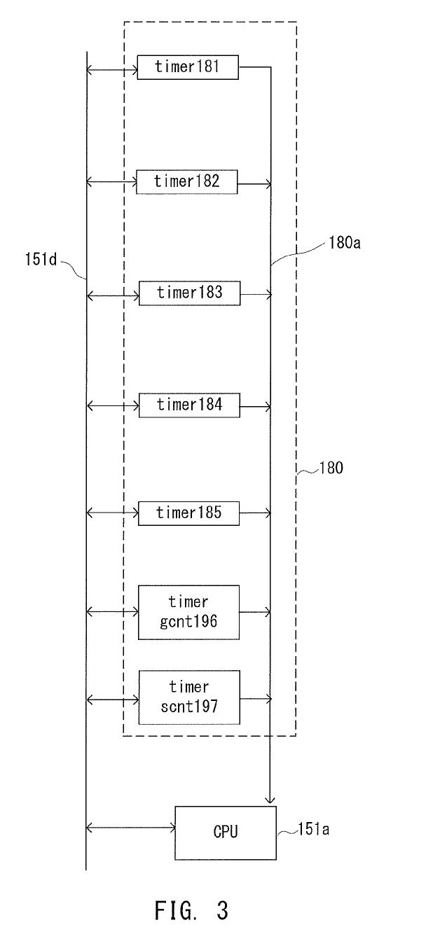

FIG. 2 is an explanatory block diagram for illustrating an example of a function configuration of the system controller 151 provided to the image forming apparatus 301. Moreover, FIG. 3 is an explanatory diagram for illustrating a function configuration of an interrupt controller IRQC 180 provided to the system controller 151. The interrupt controller IRQC 180 includes timers 181 to 185 (timer181 to timer185 in FIG. 3), a timer 196 (timer gcnt196 illustrated in FIG. 3), and a timer 197 (timerscnt197 illustrated in FIG. 3).

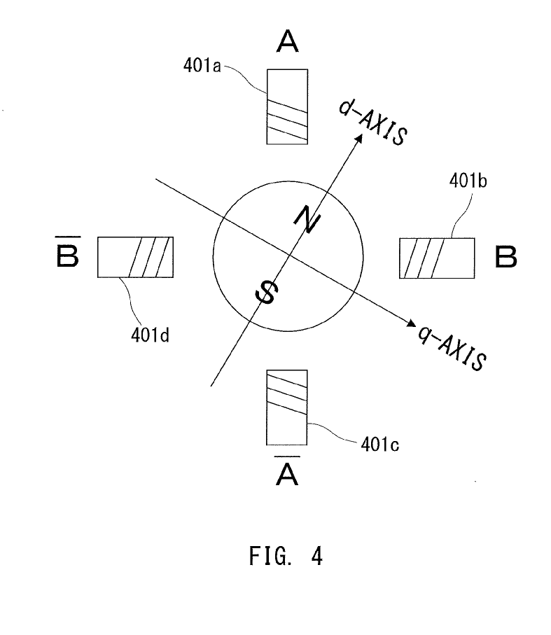

Moreover, FIG. 4 is a schematic view for illustrating an example of a configuration of a stepping motor 167a. For example, as illustrated in FIG. 4, the stepping motor 167a is a two-phase step motor including coils of two phases including an A-phase (coils 401a and 401c) and a B-phase (coils 401b and 401d).

The system controller 151 illustrated in FIG. 2 includes a central processing unit (CPU) 151a, a read only memory (ROM) 151b, a random access memory (RAM) 151c, an operation unit 152, and A/D converters 153a and 153b. The A/D converters 153a and 153b are each an example of a current detector of an analog/digital conversion type.

Moreover, the system controller 151 includes a DC load controller 158a, an AC driver 160, a general purpose input output (GPIO) 170, the interrupt controller IRQC 180, and pulse width modulation (PWM) function portions (PWMs 506a to 506e in FIG. 2).

The system controller 151 is configured to communicate information with each of function portions provided to the image forming apparatus 301. For example, the system controller 151 is connected to an image processor 102 through a bus 151d.

The system controller 151 controls drive of loads provided to the image forming apparatus 301 through a DC load controller 158a. Moreover, the system controller 151 receives output from sensors 159a, and analyze the received information. Moreover, the system controller 151 controls, for example, exchange of data with a user interface through the operation unit 152. As described above, the system controller 151 collectively controls various operations of the image forming apparatus 301.

The CPU 151a reads and executes a program stored in the ROM 151b to execute various sequences associated with image formation sequences set in advance. The CPU 151a is capable of communicating with each of modules in the system controller 151 through the bus 151d.

The RAM 151c temporarily or permanently stores various data. The RAM 151c stores, for example, a high voltage setting value for a high-voltage controller 155, various data, and image formation command information received through the operation unit 152.

Moreover, the system controller 151 transmits various data required for image processing to the image processor 102. Further, the system controller 151 receives, for example, density signals of an original image (signals from the sensors 159a) through the GPIO 170.

The system controller 151 changes the setting values of the high-voltage controller 155 or controls an output voltage of a high-voltage unit 156 (unit configured to control the charging device 310, the developing device 314, and the transfer/separation device 315) based on the received signals, to thereby perform optimum image formation.

The system controller 151 changes settings of the image processor 102. Moreover, detection signals of a thermistor 154 having been converted into digital signals by the A/D converter 153a are taken into the system controller 151, and the AC driver 160 is controlled based on those signals.

In such a manner, the system controller 151 performs control so that a fixing heater 161 reaches a desired temperature.

The system controller 151 acquires, through the operation unit 152, various information related to image formation, such as a copy magnification or a density setting value which are set by a user.

Moreover, the system controller 151 provides, through the operation unit 152, various information related to a state of the image forming apparatus 301, for example, information related to the number of images being formed, whether or not an image is being formed, occurrence of jamming, and a position at which the jamming occurs.

Moreover, the system controller 151 and the operation unit 152 communicate with each other various settings related to the tab sheet and various information for indication of alert with respect to the tab sheet.

The operation sequences in the image forming apparatus 301 are executed by the CPU 151a of the system controller 151 in the manner described above. Moreover, at the time of image formation, operations of the drive sources (for example, stepping motors 167a to 167e) configured to drive, for example, conveyance rollers configured to convey a recording medium are also controlled.

For example, the system controller 151 outputs PWM signals 171a to 175b in predetermined time cycles to the motor drive controllers 157a to 157c corresponding to the stepping motors 167a to 167e, respectively. With this, for example, a rotation position and a rotation speed for each drive source are controlled.

In FIG. 2, the motor drive controller 157a corresponding to the stepping motor 167a, the motor drive controller 157b corresponding to the stepping motors 167b and 167c, and the motor drive controller 157c corresponding to the stepping motors 167d and 167e are illustrated as one example.

As described above, the system controller 151, the motor drive controllers 157a to 157c, and the stepping motors 167a to 167e function as the motor control device in the image forming apparatus 301.

The A/D converters 153a and 153b are each an 8-ch AD conversion module including an analog selector of eight channels and one A/D converter, and are each configured to sequentially perform AD conversion in a time-sharing manner on the terminals 0 to 7 in rounds.

With the two modules including the A/D converters 153a and 153b, sixteen channels are given. However, dedicated attachment circuits for the A/D conversion function are provided only for two channels. Therefore, as compared to a case in which sixteen channels of AD conversion functions each corresponding to one channel are arrayed in parallel, the circuit scale can be reduced to about one-eighth.

Motor-phase current detection signals 168a are A-phase current detection signals of the stepping motors 167a to 167e, and are connected to the terminals 0 to 4 of the A/D converter 153a.

Motor-phase current detection signals 168b are B-phase current detection signals of the stepping motors 167a to 167e, and are connected to the terminals 0 to 4 of the A/D converter 153b.

The motor-phase current detection signals 168a and 168b are simply illustrated like buses, but are ten individual signals of the five motors in two phases.

The terminal 6 of the A/D converter 153a is a terminal to which a detection signal of the thermistor 154 configured to measure the temperature inside the apparatus is connected.

The terminals 5 and 6 of the A/D converter 153b are terminals to which current detection signals of the high-voltage controller 155 are connected. As described above, the terminal 6 of the A/D converter 153a and the terminals 5 and 6 of the A/D converter 153b are for use not directly related to the motor control.

The terminal 7 of each of the A/D converters 153a and 153b is not used, and thus is grounded.

The system controller 151 (CPU 151a) performs drive control for five motors in accordance with combinations of a plurality of counter timer functions provided to the interrupt controller IRQC 180 and respective timer interrupt instructions 180a illustrated in FIG. 3.

[Position Command Pulse]

The timers 181 to 185 provided to the interrupt controller IRQC 180 are timers configured to generate position command pulses (θ_ref) for controlling acceleration, deceleration, and stop of rotation for the five motors.

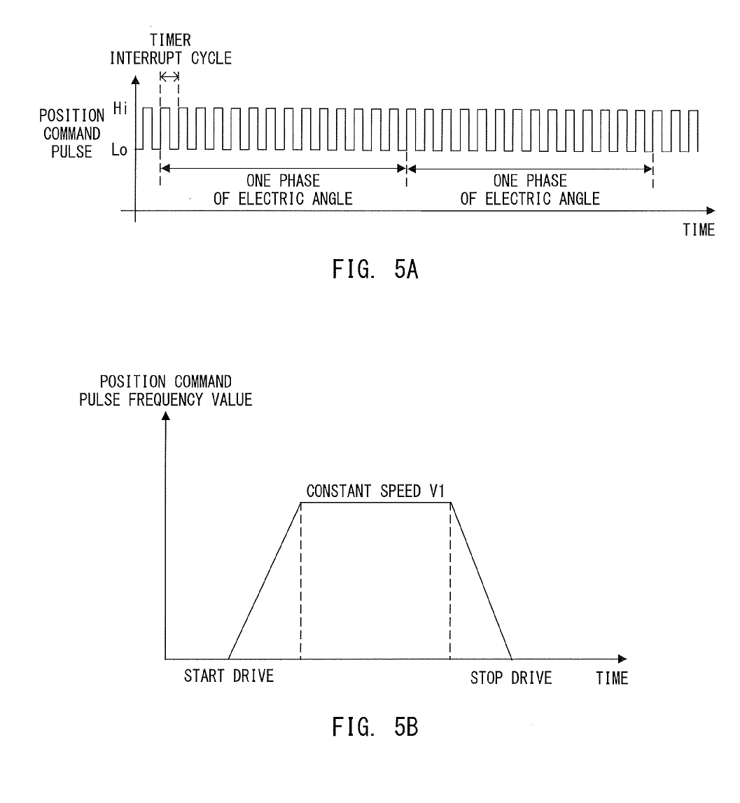

Now, with reference to FIG. 5A and FIG. 5B, description is made of interruption timings of the timer 181.

FIG. 5A is an explanatory diagram for illustrating an example of position command pulses (θ_ref) of the motor and interruption timings of the timer 181. FIG. 5B is an explanatory graph for showing an example of rotation speed control (b) for the stepping motor 167a. In the timing chart of FIG. 5A, the vertical axis represents the position command pulse, and the horizontal axis represents time. Moreover, in the graph of FIG. 5B, the vertical axis represents a position command pulse frequency value, and the horizontal axis represents time.

As illustrated in FIG. 5A, the timer 181 for a first stepping motor (for example, the stepping motor 167a) cyclically generates position command pulses θ_ref which are 8 times faster than step pulses. The 8 times corresponds to 8 pulses in 8-microstep control of a two-phase stepping motor. Position command pulse information θ_ref corresponds to information representing a timing difference in subsequent interrupt control.

The graph shown in FIG. 5B represents position command frequency values given from the start of drive of the stepping motor 167a to the stop of drive. During the stop of drive of the stepping motor 167a, the timer 181 is stopped.

At the time of the start of drive of the stepping motor 167a, cyclical generation with a self-activation pulse width is started, and a cycle of the timer 181 is gradually shortened to accelerate the motor. When the speed reaches a desired target constant speed VI, the cycle of the timer 181 is set constant during this period. In a step of stopping the stepping motor 167a, the cycle of the timer 181 is gradually extended to decelerate the motor, and the timer 181 is stopped.

[PWM Pulse]

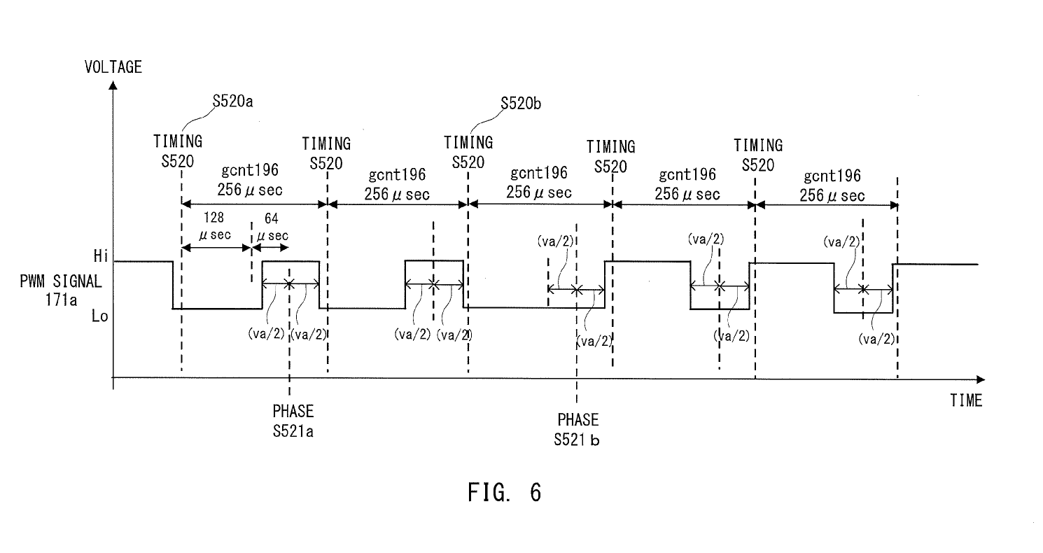

FIG. 6 is a timing chart for illustrating an example of an output value of the PWM signal 171a in the A-phase of the stepping motor 167a. In the timing chart of FIG. 6, the vertical axis represents voltage, and the horizontal axis represents time.

As illustrated in FIG. 6, the timer 196 generates identical and common PWM cycle timings (timings S520) with respect to the plurality of stepping motors. Moreover, the timer 196 generates the PWM cycle timings (timings S520) in 256 μsec cycles.

As described above, the timer 196 is used for generating common PWM cycles gcnt for excitation PWM adjustment, which is applied to the A-phase and the B-phase in common.

PWM function portions provided to the system controller 151 are function portions configured to generate PWM pulse widths for excitation PWM adjustment of respective motors with a clock counter logic.

For example, the PWM function portion is configured to generate an A-phase PWM signal 171a and a B-phase PWM signal 171b for drive control of the stepping motor 167a. Similarly, also with regard to other stepping motors, the PWM function portions corresponding respectively to the other stepping motors generate PWM signals corresponding to the A-phase and the B-phase of the motor as PWM signals 172a to 175a and 172b to 175b.

For example, as illustrated in FIG. 6, the PWM signal 171a is generated so that PWM edges (outer ends of a signal width) are generated within a time period (va/2) before and after a center corresponding to a three-fourth cycle (¾ cycle), that is, 192 μsec from the common timing (S520).

A Hi-width of the PWM signal is equal to or less than 256 μsec, and is modulated based on a detection result of an electric angle and a current as well as a calculation result of a drive algorithm.

[AD Convert Cycle]

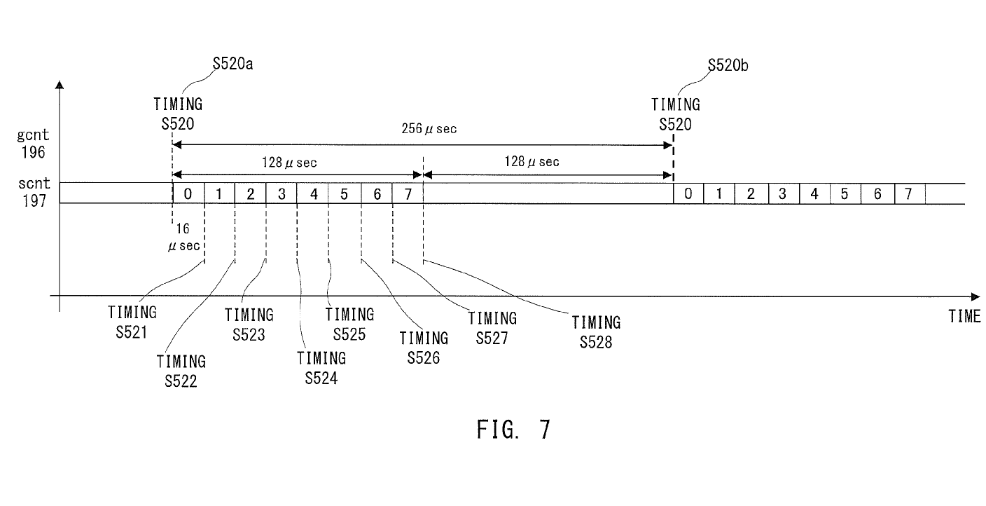

FIG. 7 is a timing chart for illustrating an example of detection timings of the A/D converters 153a and 153b through interruption by the timer 196 (gcnt196) and the timer 197 (scnt197). In FIG. 7, the values in the timer 197 (scnt197) correspond to numbers of input terminals which read two data pieces of the A/D converters 153a and 153b just before.

As illustrated in FIG. 6, the PWM signal 171 is generated so that the PWM edges (outer ends of the signal width) are generated within a time period (va/2) before and after the center corresponding to the three-fourth cycle, that is, 192 μsec from the common timing (S520). That is, during a time period from the common timing (S520) to a one-half cycle, the edge of the PWM is not generated. Therefore, the AD conversion timings are set through use of the timer 196 (gcnt196) so that eight inputs of each of the A/D converters 153a and 153b can be subjected to the AD conversion during the period from the common timing (S520) to the one-half cycle.

That is, the A/D converter is capable of converting the plurality of drive currents corresponding to the plurality of motors into digital values outside a predetermined phase range in the PWM cycle.

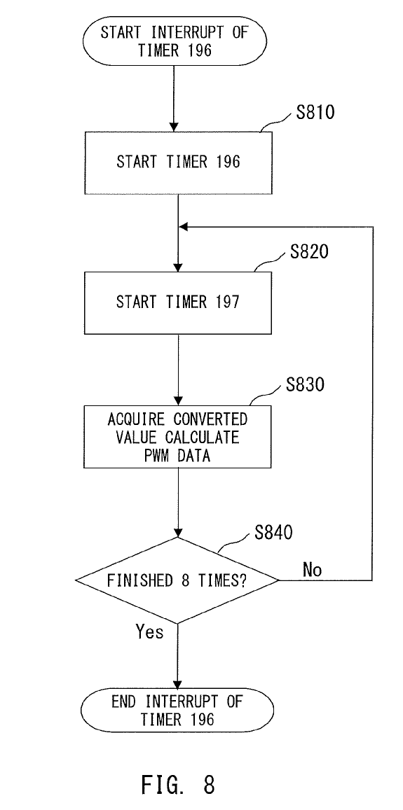

FIG. 8 is a flow chart for illustrating an example of the timer interrupt control performed by the interrupt controller IRQC 180.

FIG. 8 is an illustration of an example of processing procedures in interruption tasks of the timer 196 and the timer 197 in the interrupt controller IRQC 180, and the timers in the interrupt controller IRQC 180 are controlled based on instructions given by the CPU 151a.

Now, description is made with an example of a case in which the stepping motor 167a is a motor to be controlled.

When an interruption task of the timer 196 is started, the CPU 151a starts operation of the timer 196 (Step S810). The timing of starting operation of the timer 196 corresponds to the PWM cycle timing S520 of FIG. 6. Further, the CPU 151a starts operation of the timer 197 (Step S820). In this embodiment, the CPU 151a causes the timer 197 to successively operate 8 times during one operation of the timer 196 (corresponding to 0 to 7 illustrated in FIG. 7).

Next, the CPU 151a causes the motors corresponding to the number of repetition of the AD conversion to perform the AD conversion of a corresponding current value, and acquires AD convert values. Further, the CPU 151a calculates PWM data pieces of the motors corresponding to the number of repetitions of the timer (Step S830).

The CPU 151a successively repeats the start of the timer 197 (Step S820) and calculation of the PWM data pieces (Step S830) 8 times (Step S840).

When the timer 196 counts up to a predetermined value, the CPU 151a starts the processing of the interruption task of the timer 196 illustrated in FIG. 8 again. That is, as illustrated in FIG. 6 and FIG. 7, the processing starting from the timing S520 is repeated.

In this embodiment, the timer 196 generates the PWM cycle timings in the 256 μsec cycle, and the timer 197 generates the AD convert timings in the 16 μsec cycle (FIG. 7: timings S521 to S528).

Then, as illustrated in FIG. 6, the PWM function portion generates the PWM signals in the PWM cycles (256 μsec) in synchronization with the PWM cycle timings S520.

As described above, the CPU 151a performs control of allowing the A/D converters to be shared through the PWM function portions provided to the system controller 151 in accordance with combinations of the seven counter timer functions in the interrupt controller IRQC 180 and the respective timer interrupt instructions 180a.

In such a manner, the CPU 151a performs drive control for the five motors including the stepping motor 167a with two PWMs including the A-phase and the B-phase.

Now, description is made of successive calculation for determining a pulse width of the PWM signal based on the AD convert value.

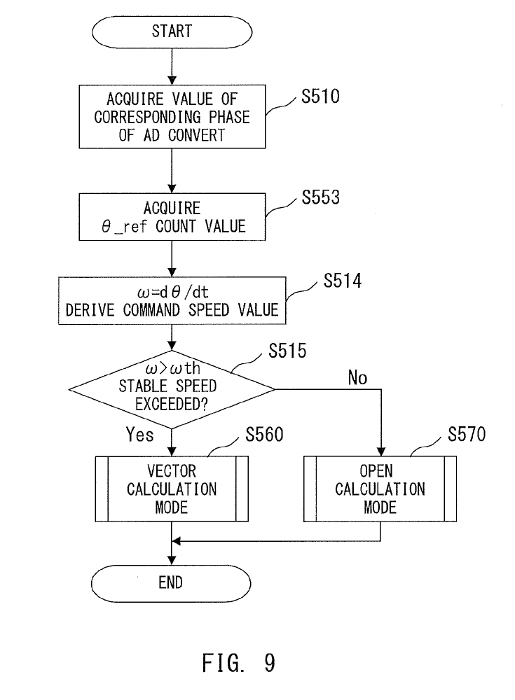

FIG. 9 is a flow chart for illustrating an example of the processing of Step S830 illustrated in FIG. 8, that is, the processing of acquiring the AD convert value and calculating the PWM data. Description is made with an example of a case in which the stepping motor 167a is a motor to be controlled. Moreover, each processing illustrated in FIG. 9 is controlled by the CPU 151a.

The CPU 151a causes the motors corresponding to the number of repetitions of the AD conversion to perform the AD conversion of a corresponding current value, and acquires AD convert values (Step S510). The acquired AD convert values are stored in, for example, the RAM 151c.

The CPU 151a acquires a position command pulse (θ_ref) count value being a time value corresponding to a period from a position command pulse (θ_ref) to present current detection interruption (Step S553). The acquired position command pulse (θ_ref) count value is stored in, for example, the RAM 151c.

Based on a difference between the acquired position command pulse (θ_ref) count value and a position command pulse (θ_ref) count value given at the time of previous interruption (temporal change of electric angle θ), the CPU 151a derives a command speed value w being cycle information of the present position command pulse (Step S514).

The CPU 151a determines whether or not the derived command speed ω is higher than a threshold speed ωth (Step S515). In such a manner, determination is made in the processing of Step S515 on whether or not the command speed exceeds a stable speed.

When the command speed w is higher than the constant speed value (ωth) (Step S515: Yes), the CPU 151a shifts to a vector calculation mode (Step S560). Moreover, when the command speed w is not higher than the constant speed value (ωth) (Step S515: No), the CPU 151a shifts to an open calculation mode (Step S570).

In such a manner, depending on whether or not the command speed exceeds the stable speed, a motor control method for controlling the stepping motor 167a is specified.

[Vector Mode Calculation]

Now, description is made of a vector mode calculation. This method has a basic configuration corresponding to inverter control using coordinate conversion, which is used for a brushless DC motor, an AC servomotor, and the like.

Specifically, a stationary coordinate system indicating normal current vectors flowing through the A-phase and the B-phase of the stepping motor 167a is converted into a rotary coordinate system with a magnetic pole direction of the rotor defined as “d-axis” and a direction further proceeding by 90 degrees defined as “q-axis” as illustrated in FIG. 4. This inverter control has a configuration of two control calculation loops including position PID control and current PID control.

In the position PID control configured by a proportional-integral compensation step, based on a detected electric angle θ of the output shaft of the stepping motor 167a and the position command pulse (θ_ref) count value, current command values iq_ref and id_ref are derived so that deviation of the detected electric angle θ of the output shaft of the stepping motor 167a and the position command pulse (θ_ref) count value becomes smaller.

In the vector control, it is required that position information of the stepping motor 167a be provided as feedback to the position control in order to perform the position PID control.

Typically, in order to detect those information pieces, a rotary encoder is mounted to the stepping motor, and the position information is acquired based on the number of output pulses of the rotary encoder. Then, speed information is acquired based on an output pulse cycle in the acquired position information.

However, when the rotary encoder which is not originally required for the drive of the stepping motor, there arise problems such as increase in manufacturing cost for the device and need for arrangement space. Thus, there has been proposed sensorless control of estimating position and speed information of the stepping motor 167a without use of the encoder.

However, in the vector control through the induced voltage component detection of the sensorless control described above, rotation at the constant speed (ωth) or higher is required.

Therefore, it is configured so that, under a limited control state in which the speed given at the time of activation or stop of the stepping motor is extremely low, the mode is switched to the above-mentioned open calculation mode (open control: determination of an excitation PWM cycle for each phase based on current detection for each phase). The drive of the stepping motor may be controlled in such a manner.

FIG. 10 is a flow chart for illustrating an example of the PWM data calculation processing in Step S560 (vector calculation mode) illustrated in FIG. 9.

The CPU 151a performs induced voltage calculation (Step S512a).

Specifically, the CPU 151a derives AC currents iα and iβ and drive voltages vα and vβ of the stepping motor 167a. The AC current is corresponds to the AD convert value acquired from the A/D converter 153a, and the AC current iβ corresponds to the AD convert value acquired from the A/D converter 153b.

Then, based on the input current values and the output voltage values, the CPU 151a estimates induced voltages Eα and Eβ of the stepping motor 167a in accordance with the following voltage equations in a motor equivalent circuit. The induced voltages Eα and Eβ can be derived through use of Expressions (1) and (2) described below.

Eα=Vα−R*iα−L*diα/dt (1)

Eβ=Vβ−R*iβ−L*diβ/dt (2)

In Expressions (1) and (2), R represents a coil resistance, and L represents a coil reactance. The values of R and L are stored in advance in the ROM 151b.

The CPU 151a performs position calculation to derive the electric angle θ of the stepping motor 167a (Step S513). The electric angle θ can be derived using an inverse trigonometric function (arctangent), e.g., Expression (3) described below.

θ=A TAN(−Eβ/Eα) (3)

The derived electric angle θ is provided as feedback to the above-mentioned position PID control (Step S502). Moreover, the derived electric angle θ is used also in coordinate conversion processing (Step S505).

[Current Control]

The current values flowing through the phases of the motor are detected as current detection signals 168a and 168b by the A/D converters 153a and 153b, and are acquired by the CPU 516a in the processing of current detection (Step S510 in FIG. 9).

The CPU 151a performs the position PID control (Step S502). Specifically, the CPU 151a derives the current command values iq_ref and id_ref based on the position command pulse (θ_ref). The current command values iq_ref and id_ref are command values which are given after the conversion calculation from the αβ axis to the dq axis.

The CPU 151a performs coordinate conversion processing (Step S503). Specifically, the CPU 151a defines the currents flowing through the stepping motor 167a as iα=I*cos θ and iβ=I*sin θ in the stationary coordinate system, and defines θ as a relative angle (electric angle) formed between the a-axis in the stationary coordinate system and a rotor magnetic flux. In this case, the current values in the rotary coordinate system can be expressed by id=cos θ*iα+sin θ*i and iq=−sin θ*iα+cos θ*iβ.

Through this conversion, the AC currents iα and iβ respectively flowing through the A-phase and the B-phase and the current command values iq_ref and id_ref can be expressed by the DC current. The d-axis current is a component capable of controlling a magnetic flux amount, and does not contribute to torque. Meanwhile, the q-axis current is a component which governs generated torque of the stepping motor 167a.

In such a manner, the d-q conversion is performed through the coordinate conversion processing (Step S503), and the q-axis current iq and the d-axis current id are obtained. Deviation between the obtained q-axis current and d-axis current and the current command values iq_ref and id_ref output from the above-mentioned position PID control (Step S502) is used for the current PID control (Step S504). In a typical vector control, the d-axis current is controlled so that the id component which does not contribute to the torque is set to 0.

The CPU 151a performs the current PID control (Step S504). Specifically, similarly to the position PID control (Step S502), the CPU 151a amplifies the current deviation amount through the proportional-integral compensator and thereafter performs the coordinate conversion processing. In such a manner, the CPU 151a reversely converts the current values iq and id into current amounts iα and iβ in the stationary coordinate system. Moreover, the reverse conversion can be performed through use of Expressions (3) and (4) described below.

iα=cos θ*iq−sin θ*id (3)

iβ=sin θ*iq+cos θ*id (4)

The CPU 151a derives the drive voltages vα and vβ based on the current values is and iβ given after the conversion (Step S505).

The CPU 151a performs reservation setting of inversion timings for the PWM signals (Step S506). Specifically, the CPU 151a performs reservation setting to a register based on the drive voltages vα and vβ so that the PWM signals 171a and 171b function. In such a manner, the interruption task by the timer 197 per motor is terminated. A generation pattern of the PWM signals is given as illustrated in the timing chart of FIG. 6.

Through construction of such feedback system, in the vector control, a minimum required drive current corresponding to a load is always applied to the motor, thereby being capable of achieving power-saving and small-noise motor drive.

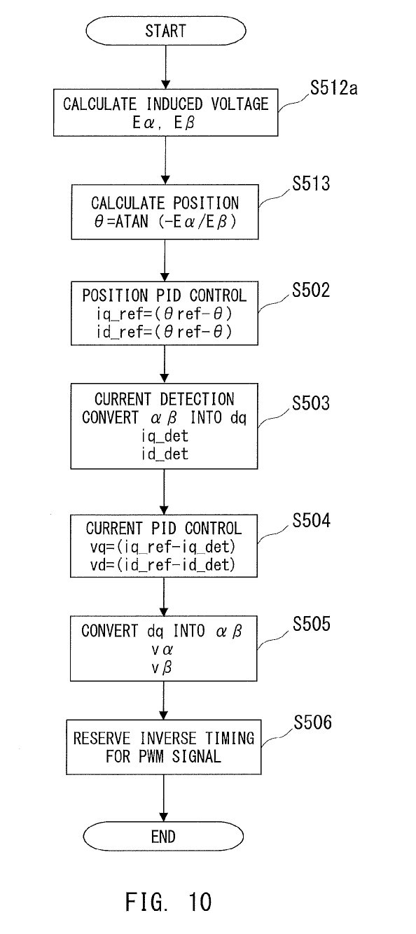

FIG. 11 is a flowchart for illustrating an example of PWM data calculation processing in Step S570 (open calculation mode) illustrated in FIG. 9.

The CPU 151a performs induced voltage calculation (Step S512b). Specifically, the CPU 151a derives the AC currents iα and iβ, which have been converted into digital values by the A/D converters 153a and 153b, and the drive voltages vα and vβ of the stepping motor 167a.

Then, based on the input current values and the output voltage values, the CPU 151a estimates the induced voltages Eα and Eβ of the stepping motor 167a with the following voltage equations in the motor equivalent circuit.

The CPU 151a sets target currents (ia_ref and ib_ref) (Step S517).

The CPU 151a performs the current PID control (Step S518). Specifically, similarly to the position PID control (processing of Step S502 illustrated in FIG. 10), the CPU 151a amplifies the current deviation amount through the proportional-integral compensator and thereafter performs the coordinate conversion processing.

The CPU 151a performs reservation setting for inversion timings of the PWM signals (Step S519).

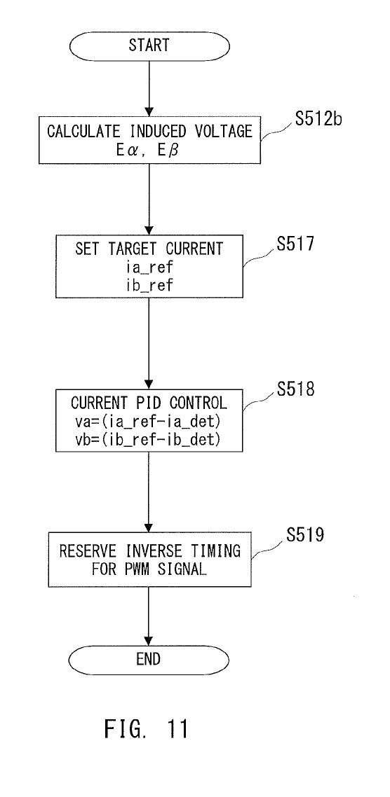

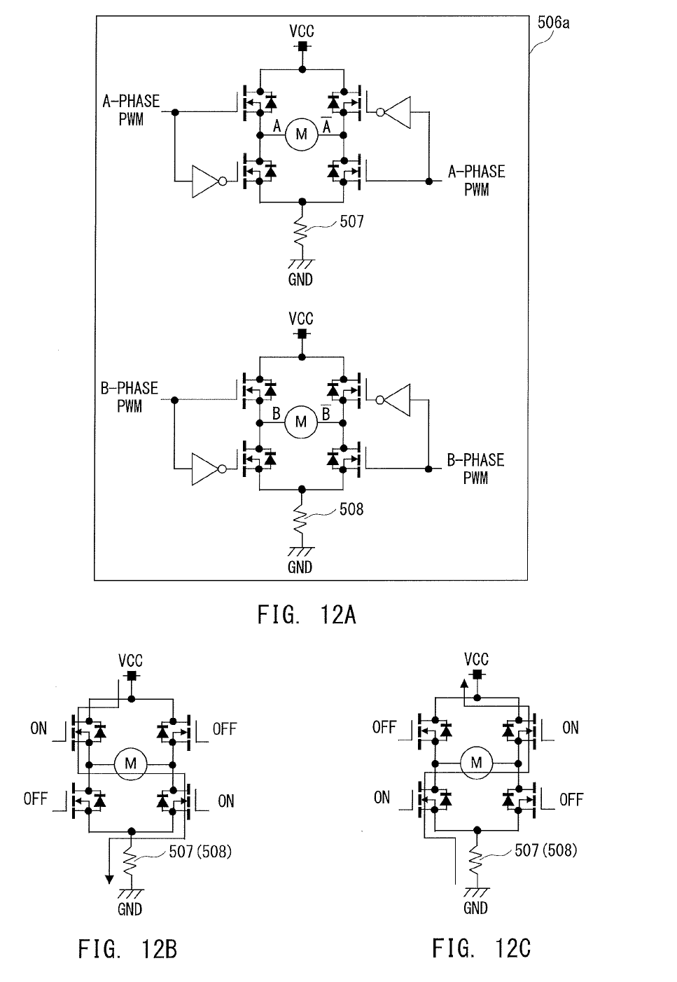

FIG. 12A, FIG. 12B, and FIG. 12C are each an explanatory diagram for illustrating an example of a full bridge circuit of the PWM function portion.

Moreover, as illustrated in FIG. 12A, the PWM function portion (for example, the PWM 506a) provided to the system controller 151 is formed of a full bridge circuit using FETs, and in a case of the two-phase stepping motor, includes two full bridge circuits for the A-phase PWM and the B-phase PWM.

Moreover, FIG. 12B is an illustration of an orientation of a drive current flowing through a motor coil when the PWM signal is in a Hi state, and FIG. 12C is an illustration of an orientation of the drive current flowing through the motor coil when the PWM signal is in a Low state.

The full bridge circuit includes four FETs including right and left FETs on a high side (high region) close to a power supply voltage and right and left FETs on a low side. The PWM signals indicating the drive voltages are connected to the gate signals of FETs on a high-side left side and a low-side (low-region) right side, and inversion signals of the PWM signals are connected to other high-side right side and low-side left side. With this configuration, a ratio of a Hi width of the PWM signal (hereinafter referred to as “PWM signal positive duty”) in the PWM control cycle is adjusted, thereby being capable of allowing a desired drive voltage to be applied to both ends of the motor coil and allowing the drive current to flow through the motor coil.

The drive current flowing through each phase of the motor amplifies the voltage to be applied to current detection resistors 507 and 508, which are arranged on a full bridge circuit ground side, through use of an operational amplifier (not shown), and converts the voltages into digital signals through use of the A/D converter. Then, the CPU 151a acquires the converted digital signals.

At this time, switches (switching elements) of the FETs are turned on and off to apply a desired drive voltage to the motor coil, and hence the PWM signal repeats the Hi state and the Low state. At the time of switching of the Hi state and the Low state, switching noise of the FETs is generated. Therefore, it is preferred that a current detection time (predetermined time) be set at a center portion of each of the Hi width and the Low width of the PWM signal.

As described above, in a case of performing digital calculation of a triangular wave comparison method in which a triangular wave is used as a carrier and a motor drive voltage is used as a modulated wave, a change time of the modulated wave is synchronized with a time of a crest or a trough of the triangular wave.

Moreover, as a method of detecting the drive current, there is given a case in which the shunt resistor is arranged on the ground side of the bridge circuit, and the voltage applied to the resistor is amplified with the operational amplifier and detected through use of the A/D converter. In this case, as illustrated in FIG. 12B and FIG. 12C, even when the orientation of the drive current flowing through the motor is constant, there may occur an event in which the orientation of the detected current flowing through the shunt resistor is different between the case in which the PWM signal is in the Hi state and the case in which the PWM signal is in the Low state.

Therefore, in order to match the orientation of the detected current, the CPU 151a inverts the sign of the detected current value in accordance with at which of the time in the Hi state of the PWM signal or the Low state of the PWM signal the current is detected. In accordance with positive or negative of the drive voltage, which of the Hi width and the Low width of the PWM signal is relatively longer is determined.

[Timing Control]

As described above, the system controller 151 (CPU 151a) performs polarity control with a phase of performing current detection at the timing of 192 μsec, which is delayed by three-fourths (¾) cycle from the PWM cycle timing (FIG. 6: timing S520).

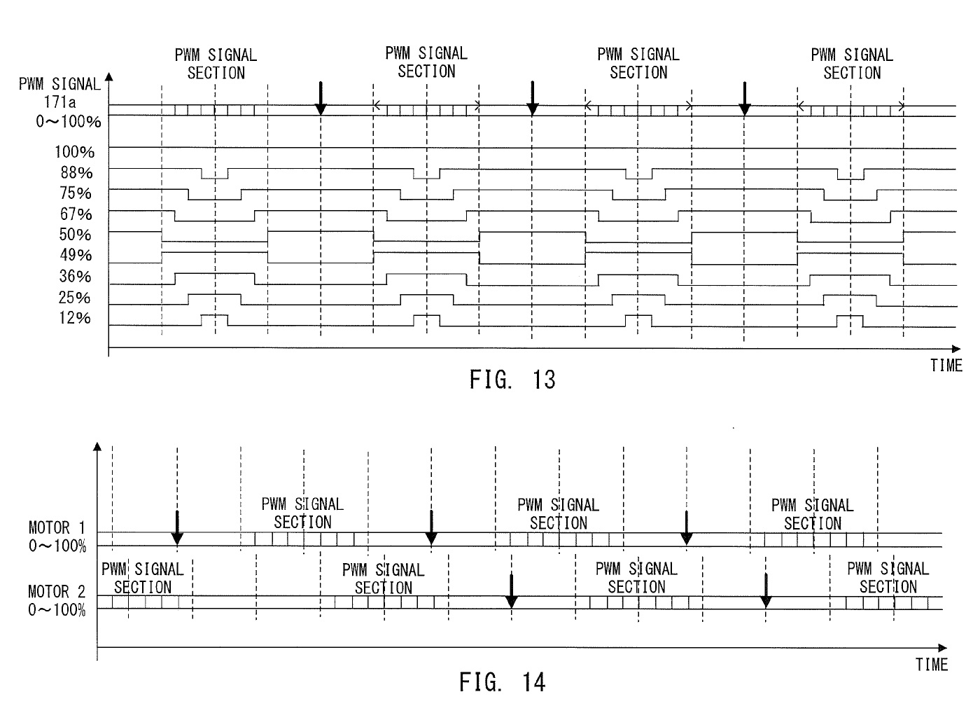

FIG. 13 is a graph for showing an example of a relationship between PWM generation sections (PWM signal sections) and AD convert timings (timings indicated by the arrows in FIG. 13) with regard to four PWM signals 171a and three AD converts based on the phase, in which the PWM widths are illustrated next to each other in a stepwise manner (each indicated by %). In the graph of FIG. 13, the vertical axis represents the PWM width of the PWM signal 171a, and the horizontal axis represents time.

Similarly, also with regard to other stepping motors, PWM signals with respect to the A-phase and the B-phase of the motor are generated as the PWM signals 172a to 175a and 172b to 175b by corresponding PWM function portions.

As shown in FIG. 13, the CPU 151a controls the PWM signals so that, at the Hi width and Low width of the PWM signal for each PWM cycle (each PWM output cycle), a center position of the shorter width (center value of the shorter width) is delayed by three-fourths (¾) cycle in phase. The center position of the shorter width is present within a predetermined phase range in the PWM cycle. Through this polarity control, the edge of the PWM signal appears only in a half phase in a latter half of the PWM cycle at the timing S520.

For example, at the PWM cycle timing S520a illustrated in FIG. 6, with the phase S521a having a center of the Hi width delayed by three-fourth cycle as a center, the PWM signal is shifted in the order of Hi and Low. Moreover, at the PWM cycle timing S520b, with the phase S521b having a center of the Low width delayed by three-fourth cycle as a center, the PWM signal is shifted in the order of Low and Hi.

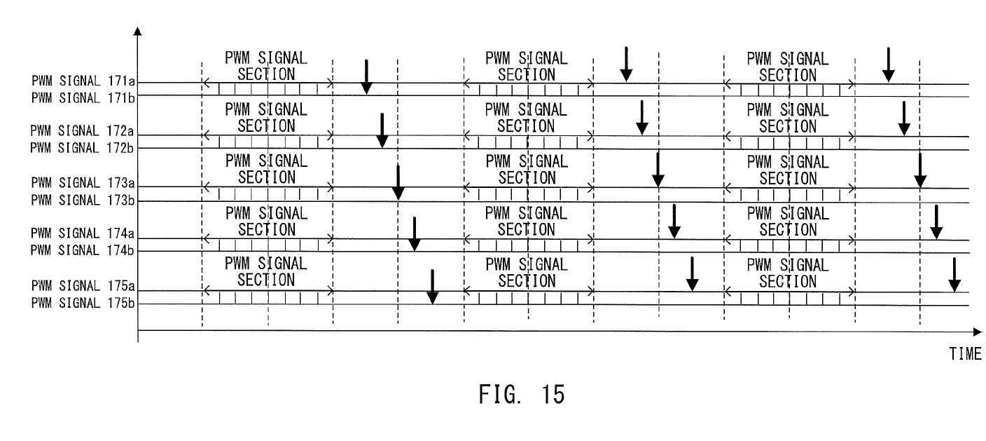

Moreover, FIG. 14 is a graph for showing an example of a relationship between PWM generation sections (PWM signal sections) and AD convert timings (timings indicated by the arrows in FIG. 14), in a case in which PWM widths of the PWM signals with respect to two motors 1 and 2 in a related-art example.

In the graph of FIG. 14, the vertical axis represents the motors 1 and 2, and the horizontal axis represents time. In the related art, no common PWM cycle timing (timing S520) is given, and hence phases of the PWM cycles of the motors are shifted from each other.

In FIG. 14, it can be seen that, at the AD convert timings of the motors, PWM edges of the motors interfere with each other in some cases.

With the method of the related art as shown in FIG. 14, the switching noises of the FET are significantly influenced by 24 V power supply ripples or magnetic waves. Therefore, a configuration in which the A/D converter is shared by a plurality of phases, AD convert accuracies of other phases may be adversely affected.

Therefore, addition of a noise filter component or arrangement of shield lines is required. Moreover, it is required to refrain from sharing the A/D converter and provide analog separation. Accordingly, there may occur increase in cost.

However, in the control of the motor control device according to this embodiment, the current detection and excitation PWM timing control are performed through sharing of the timer 197 to perform phase adjustment.

With this, during a period of former half 128 μsec at the timing S520 illustrated in FIG. 6, all of the AD convert timings (FIG. 7: timings S521 to S528) can be concentrated in the A/D converters 153a and 153b shared.

Further, successive vector calculation for two phases of all of the motors is performed by the CPU 151a, and hence all of the PWM shifts can be concentrated in the period of the latter half 128 μsec. As described above, the shift timings are adjusted so as to fall within the certain phase range. Moreover, the current detection timings fall out of the range of the shift timings.

FIG. 15 is a graph for showing an example of a relationship between the PWM generation sections (PWM signal sections) and the AD convert timings (timings indicated by the arrows in FIG. 15) in a case in which five motors are controlled by the timing control of the system controller 151 (CPU 151a).

As shown in FIG. 15, it can be seen that, through the timing control by the system controller 151 (CPU 151a), adjustment is made so that AD conversion accuracies are not degraded in the motors.

As described above, in the image forming apparatus 301 in this embodiment, even when the A/D converters are shared by the plurality of motors, control can be performed so that degradation in AD convert accuracy can be prevented by the FET switching noises caused by the motor excitation PWM edges.

On this occasion, even when the A/D converters are shared by the plurality of motors, only the phases of the PWM are matched. Therefore, activation, stop, and rotation speed can be individually and freely configured, and hence there is no limitation on the drive. Moreover, with the arrangement of the plurality of motors at respective positions in the apparatus, even when the analog current detection signals of the motors are transferred with bundled lines to the A/D converters, there is no need to provide excessive shield lines or bundle separation, and the circuit can be mounted at low cost while not adversely affecting the AD conversion accuracy.

Moreover, there is no switching in detection times, and the detection intervals can always be set constant. Therefore, the current detection circuit can be shared through use of lower-speed current detector. With this, a low-speed A/D converter which is low in cost can be selected, and hence a larger number of motors can be driven through the vector control with a smaller number of A/D converters.

Moreover, the detection intervals can always be set constant. A calculation circuit portion for an estimated electric angle which is low in speed can be shared, and hence a low-speed calculation circuit such as a low-speed CPU which is low in cost can be selected. Therefore, a larger number of motors can be driven through the vector control in a smaller calculation circuit scale.

Moreover, there can be provided a configuration of sharing one A/D converter. However, when current detection for two-phase stepping motor with two A/D converters is configured, current detection times can be matched in good order always at the same time among the plurality of phases of the plurality of motors. Therefore, accurate current detection without time deviation can be performed, and stable motor drive without unevenness in rotation of the motor drive and vibration. Thus, cost performance can be improved.

In the image forming apparatus 301 in this embodiment, in order to fix the phase relationship among the plurality of current detection timings of the plurality of the motors in the case of sharing the A/D converters in time sharing, the cycles of the PWM can be shared, ant the phase relationship can be adjusted.

Moreover, based on the output drive voltages, the method of generating the PWM signals is changed, and the PWM signals of the plurality of motors can be generated so that, without change in ratio (duty ratio) of the Hi width and the Low width, the pulse shift time of the PWM signal appears at constant phases.

It may also be configured so that the phase adjustment can be performed through use of the common PWM cycle timer 196 and the AD convert interval timer 197. In this case, while the AD convert timings are concentrated in a predetermined phase to be shared, and a predetermined non-detection time is provided. Alternatively, the order of detection can be changed in accordance with arrangement and characteristic of each motor.

For example, there is a case in which, with respect to the arrangement of the motors or motor drives or the response delay characteristics, an output value is delayed by 50 μsec with respect to the input PWM waveform. In this case, in accordance with such event, adjustment is made so as to delay by 50 μsec through use of the common PWM cycle timer 196 and the AD convert interval timer 197. With this, adjustment to a predetermined phase having less noise can be made to improve accuracy.

The above-described embodiments are given just for the purpose of describing the present disclosure more specifically, and the scope of the present disclosure is not limited by the embodiments. Further, according to the present disclosure, degradation in mutual AD convert accuracy can be suppressed even when an A/D converter is shared by a plurality of motors.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A motor control device configured to control a plurality of motors, comprising:
a generator configured to generate a plurality of PWM signals in association with the plurality of motors;
a motor drive controller configured to output a plurality of drive currents corresponding to the plurality of motors based on the plurality of PWM signals having been generated; and
an A/D converter configured to convert the plurality of drive currents into digital values;
wherein a plurality of PWM cycles of the plurality of PWM signals are the same,
wherein, in the plurality of PWM signals, a shorter width of a width of a high region of a PWM signal and a width of a low region of the PWM signal in each of the plurality of PWM cycles is present within a predetermined phase range in the each of the plurality of PWM cycles, and
wherein the A/D converter converts the plurality of drive currents corresponding to the plurality of motors into digital values at different timings outside the predetermined phase range in the each of the plurality of PWM cycles.

2. The motor control device according to claim 1,
wherein the A/D converter includes a first A/D converter and a second A/D converter,
wherein the first A/D converter converts drive currents in a first phase of each of the plurality of motors into digital values, and
wherein the second A/D converter converts drive currents in a second phase of each of the plurality of motors into digital values.

3. The motor control device according to claim 2, wherein the generator generates the plurality of PWM signals based on the digital values.

4. The motor control device according to claim 1, further comprising a first timer and a second timer,
wherein the motor control device controls the plurality of PWM cycles based on an output value of the first timer,
wherein the motor control device controls, through use of the second timer, the different timings at which the A/D converter converts the plurality of drive currents into the digital values, and
wherein the second timer starts counting in synchronization with the output value of the first timer.

5. The motor control device according to claim 1, wherein a center value of the shorter width of the width of the high region of the PWM signal and the width of the low region of the PWM signal in each of the plurality of PWM cycles is at a position of ¾ cycle from start of the each of the plurality of PWM cycles.

6. A motor control device, comprising:
a plurality of motors including two or more phase coils;
a plurality of drive controllers configured to control drive of the plurality of motors, respectively;
a current detector, which is configured to detect currents flowing through at least two phases of coils among phase coils of each of the plurality of motors and perform current detection for a plurality of phases of the each of the plurality of motors, and is shared by the plurality of motors; and
a timing controller configured to adjust:
shift timings for generating PWM signals of two or more phases by a triangular wave comparison method for allowing the drive controller to apply desired drive voltages to coils respective coils of the plurality of motors, using a triangular wave as a carrier and a motor drive voltage as a modulated wave; and
detection timings of the current detector.

7. The motor control device according to claim 6, wherein the plurality of drive controllers are each configured as a full bridge circuit configured to drive each of the plurality of motors.

8. The motor control device according to claim 6, wherein the motor comprises a stepping motor.

9. The motor control device according to claim 6, wherein the current detector comprises a current detector of a shared analog-digital conversion type, which is configured to perform current detection for the plurality of phases of the plurality of motors in a time-sharing manner.

10. The motor control device according to claim 6, wherein the timing controller performs adjustment so that the PWM signals of the plurality of motors have the same and common cycles and that outer ends of signal width fall within a certain phase range in accordance with a duty ratio of the PWM signals, and timings of the current detection are adjusted so as to be out of the range of the shift timings.

11. The motor control device according to claim 6, wherein the timing controller is configured to:
estimate induced voltages generated in phase coils of the plurality of motors based on current values detected by the current detector;
derive an electric angle being a relative angle formed between a rotor of each of the plurality of motors and the phase coil line based on the estimated induced voltage of the phase coil line;
derive rotation speed of each of the plurality of motors based on temporal change of the derived electric angle; and
perform vector control based on the current value and the electric angle or the rotation speed in a time-sharing manner.
